(19) United States
(12) Patent Application Publication
(10) Pub. No.: US 2025/0150493 A1
(43) Pub. Date: May 8, 2025

(54) HANDLING DATA CONNECTION SESSION IN IMS NETWORK

(71) Applicant: Samsung Electronics Co., Ltd., Suwon-si, Gyeonggi-do (KR)

(72) Inventors: Murali REDDIBOYANA, Bangalore (IN); Mustque AHMED, Bangalore (IN); Gururaj B MALANNAVAR, Bangalore (IN)

(21) Appl. No.: 18/824,326

(22) Filed: Sep. 4, 2024

Related U.S. Application Data
(63) Continuation of application No. PCT/KR2024/013191, filed on Sep. 2, 2024.

(30) Foreign Application Priority Data
Nov. 8, 2023 (IN) 202341076428

(51) Int. Cl. H04L 65/1073; H04L 65/1016; H04L 65/1045; H04L 65/1069

(52) U.S. Cl. CPC H04L 65/1073; H04L 65/1016; H04L 65/1045; H04L 65/1069

(57) ABSTRACT

Methods for handling a data connection session in an Internet Protocol (IP) Multimedia Subsystem (IMS) network are provided. The method includes configuring a S50 interface between a Mobility Management Entity (MME) and a Policy and Charging Rules Function (PCRF) entity in the IMS network, and notifying a User Equipment (UE) about a Mobile Terminated (MT) Voice over LTE (VOLTE) call by using the MME. Another method includes configuring a SBI interface between an Access and Mobility Management Function (AMF) entity and the Policy Control Function (PCF) entity in the IMS network, and includes notifying a UE about a MT Voice over New Radio (VoNR) call by using the AMF entity.

### CROSS-REFERENCE TO RELATED APPLICATION(S)

This application is a continuation application, claiming priority under § 365 (c), of an International application No. PCT/KR2024/013191, filed on Sep. 2, 2024, which is based on and claims the benefit of an Indian Patent Application number 202341076428, filed on Nov. 8, 2023, in the Indian Intellectual Property Office, the disclosure of which is incorporated by reference herein in its entirety.

### TECHNICAL FIELD

The disclosure relates to an internet protocol (IP) multimedia subsystem (IMS) network. More particularly, the disclosure relates to a method for handling a data connection session in the IMS network.

### BACKGROUND

As soon as a user equipment (UE) is switched on, ‘Internet’ and ‘IMS’ protocol data unit (PDU) sessions/packet data network (PDN) connections are established. The UE may not use the IMS PDU session/PDN connection most of the times. There is a mechanism to release a N3 tunnel and radio bearers when there is no traffic on the IMS PDU session/PDN connection. However, a fifth generation (5G)/a fourth generation (4G) core network still holds N6/S (Gi) information towards the IMS network including UE internet protocol (IP) address of the IMS PDU session/PDU connection. Further, in 5G, a 5G quality of service (QOS) identifier (5QI)=1 is released after a Voice over New Radio (VoNR), but the 5QI=5 is still retained. Similarly, QCI=1 and QCI=5 are used in long term evolution (LTE)/4G core network. This is to enable other IMS users to reach out to the 5G/4G UE using a session initiation protocol (SIP) signalling over the 5QI=5 (i.e., IMS default bearer). The UE also continue to hold the IMS PDU session/PDN connection context. In the existing 3rd generation partnership project (3GPP) architecture, the 4G/5G core network continues to hold the IMS PDU session/PDN connection IP address of the UE along with UE context as long as the UE is powered on, irrespective of whether there is data floating on the IMS PDU session/PDN connection or not.

Hence, there is a need in the art for solutions which will overcome the above mentioned drawback(s), among others.

### SUMMARY

Aspects of the disclosure are to address at least the above-mentioned problems and/or disadvantages and to provide at least the advantages described below. Accordingly, an aspect of the disclosure is to provide methods for handling a data connection session in an IMS network.

Another aspect of disclosure is to set up an IMS PDU session/PDN connection when required (On-demand IMS PDU session/PDN connection for a VoNR/a voice over LTE (VOLTE)) and release the PDU session/PDN connection when it is not required.

Another aspect of disclosure is to provide that when the IMS PDU session/PDN connection is released when there is no data floating on the IMS PDU session/PDN connection for specified amount of time, even a UE IP address of the IMS PDU session/the PDN connection is released including the UE context of the IMS PDU session/PDN connection. Hence, the released IMS UE IP address may be used for other UEs who make IMS PDU session/PDN connection. So that, limited number of IMS UE IP addresses are sufficient to serve a greater number of IMS UEs, as all the UEs may not require IMS PDU session/PDN connection at the same time. Thus, an operator may plan more Internet IP addresses and less IMS IP addresses which may increase number of subscribers supported by a core network.

Another aspect of disclosure is to provide increase number of subscribers supported by the core network (e.g., 4G core network, 5G core network) with same physical resources by having more Internet IP addresses and less IMS IP addresses. The IMS IP addresses are reused across the subscribers (assigned on need basis). Every UE needs Internet PDU session/PDN connection. However, IMS PDU session/PDN connection may be established on the need basis.

Another aspect of disclosure is to define a S50 interface between a mobility management entity (MME) and a policy and charging rules runction (PCRF) entity, and Rx messages to notify UE about mobile terminated (MT) VOLTE call.

Another aspect of disclosure is to configure a service based interface (SBI) interface between an access and mobility management function (AMF) and a policy control function (PCF) entity, and the SBI interface between the PCF entity and an AF to notify the UE about the MT VONR call.

Additional aspects will be set forth in part in the description which follows and, in part, will be apparent from the description, or may be learned by practice of the presented embodiments.

In accordance with an aspect of the disclosure, a method for handling a data connection session in an internet protocol (IP) multimedia subsystem (IMS) network is provided. The method includes configuring a S50 interface between a mobility management entity (MME) and a policy and charging rules function (PCRF) entity in the IMS network, and notifying a user equipment (UE) about a mobile terminated (MT) VOLTE call by using the MME.

In an embodiment, the S50 interface handles at least one of a session setup request (SSR) signaling message, a session setup answer (SSA) signaling message, a session modification request (SMR) signaling message, a session modification answer (SMA) signaling message, a session release request (SRR) signaling message, a session release answer (SRA) signaling message, an initiate-registration-request (IRR) signaling message, and an initiate-registration-answer (IRA) signaling message.

In an embodiment, while establishing the MT VOLTE call, the method includes registering, by the MME, with the PCRF entity over the S50 interface, after a UE is attached in the IMS network. Further, the method includes sending, by the MME, a S50: session setup request (SSR) to the PCRF entity to setup a S50 UE session at the PCRF entity upon registering. Further, the method includes receiving, by the MME, a S50: session setup answer (SSA) from the PCRF entity, after the PCRF entity creates a UE context, based on the S50: SSR.

In an embodiment, the method includes receiving, by the PCRF entity, a Rx: registration-initiation-request (RIR) from the proxy-call session control function (P-CSCF) entity over a Rx interface, upon determining the UE is not yet registered in the IMS network by the P-CSCF entity, sending, by the PCRF entity, a Rx: registration-initiation-answer (RIA) to the P-CSCF entity based on the RIR, sending, by the PCRF entity, a S50: initiate-registration-request (IRR) to the MME over the S50 interface upon determining the UE context is already available with the PCRF entity over the S50 interface, sending, by the MME a S50: initiate-registration-answer (IRA) to the PCRF entity, sending, by the PCRF entity, a Rx: abort-session-request to the P-CSCF entity with a local_release for an abort-cause attribute value pair (AVP) to clean up the Rx session context after receiving the S50: IRA from the MME, and receiving, by the PCRF entity, a Rx: Abort-Session-Answer to from the P-CSCF entity based on the Rx: abort-session-request.

In an embodiment, the method includes sending, by the MME, a modified 4G NAS: DOWNLINK NAS TRANSPORT to the UE. The UE initiates the data connection session for the MT VOLTE, and forwarding, by the P-CSCF entity, a SIP-INVITE to the UE over the data connection session. A network initiated dedicated bearer is setup for the UE for the MT VOLTE call.

In an embodiment, the method includes modifying a Rx: registration-initiation-request (RIR) from a proxy-call session control function (P-CSCF) entity to the PCRF entity for the MT VOLTE call.

In an embodiment, the method includes modifying a Rx: registration-initiation-answer (RIA) from the PCRF entity to the P-CSCF entity for the MT VOLTE call.

In an embodiment, the method includes modifying a Rx: abort-session-request from the PCRF entity to the P-CSCF entity for the MT VOLTE call.

In an embodiment, the data connection session is one of an internet protocol (IP) multimedia subsystem protocol data unit (IMS PDU) session and a packet data network (PDN) connection session.

In an embodiment, the MME notifies the UE about the MT VOLTE call using a downlink NAS transport when the UE is not registered in the IMS network.

In accordance with another aspect of the disclosure, a method for handling a data connection session in an IMS network is provided. The method includes configuring a SBI interface between an access and mobility management function (AMF) entity and a policy control function (PCF) entity in the IMS network, and notifying a UE about a MT VoNR call by using the AMF entity.

In an embodiment, while establishing the MT VoNR call, the method includes registering, by the AMF entity, with the PCF entity over the SBI interface, after a UE is registered in a 5G network, sending, by the AMF entity, a Npcf_AMPolicyControl_Create message to the PCF entity to setup a UE session at the PCF entity, and receiving, by the AMF entity, a Npcf_AMPolicyControl_Create response from the PCF entity, after creating a UE context.

In an embodiment, the method includes receiving, by the PCF entity, a Npcf_PolicyAuthorization_Create with “mtVoNRTrigger” from a P-CSCF entity over the SBI interface upon determining the UE is not yet registered in the IMS network by the P-CSCF entity, and sending, by the PCF entity, a Npcf_PolicyAuthorization_Create response to the P-CSCF entity.

In an embodiment, the method includes sending, by the PCF entity, a Npcf_AMPolicyControl_UpdateNotify with “mtVoNRTrigger” to the AMF entity over a SBI interface upon determining that the UE context is already available with the PCF entity over the SBI interface, wherein the UE context is provided during a UE registration procedure, and includes sending, by the PCF entity, a Npcf_PolicyAuthorization_Notify to the P-CSCF entity with a localRelease EventNotification to perform a notification about an application session context termination' procedure at the P-CSCF entity.

In an embodiment, the method includes sending, by the AMF entity, a 5G NAS: DL NAS TRANSPORT to the UE. The UE initiates IMS PDU session for the MT VoNR call, and forwarding, by the P-CSCF entity, a SIP-INVITE to the UE over an IMS PDU session. A network initiated PDU session modification takes place for the UE for the MT VONR call.

In accordance with another aspect of the disclosure, an IMS network is provided. The IMS network includes a S50 interface configured between a MME and a PCRF entity in the IMS network, wherein the S50 interface is used by the PCRF entity to notify the MME about a MT VOLTE call.

In accordance with another aspect of the disclosure, an IMS network is provided. The IMS network includes a SBI interface configured between an AMF entity and a PCF entity in the IMS network, wherein the PCF entity uses the SBI to notify the AMF entity that notifies a UE about a mobile terminated (MT) VONR call.

In accordance with another aspect of the disclosure, one or more non-transitory computer-readable storage media storing one or more computer programs including computer-executable instructions that, when executed by one or more processors, cause an internet protocol (IP) multimedia subsystem (IMS) to perform operations are provided. The operations include configuring a service based interface (SBI) interface between an access and mobility management function (AMF) entity and a policy control function (PCF) entity in the IMS network, and notifying a user equipment (UE) about a mobile terminated (MT) voice over new radio (VoNR) call by using the AMF entity.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description take in conjunction with the accompanying drawings, and in which:

FIGS. 1A and 1B are a sequence diagrams illustrating a method for handling a data connection session in an IMS network during a Mobile Terminated (MT) VOLTE call, according to various embodiments of the disclosure;

FIG. 2 illustrates a fourth generation (4G) core network architecture in which the 4G core network architecture handles the data connection session in the IMS network during the MT VOLTE call, according to an embodiment of the disclosure;

FIG. 3 is a sequence diagram illustrating a method for handling an LTE/4G detach procedure, according to an embodiment of the disclosure;

FIG. 4 illustrates a S50 protocol stack proposed between an MME and a PCRF entity, according to an embodiment of the disclosure;

FIGS. 5A and 5B are a sequence diagrams illustrating a method for handling a data connection session in an IMS network during a MT VoNR call, according to various embodiments of the disclosure;

FIG. 6 illustrates a fifth generation (5G) core network architecture in which the 5G core network architecture handles the data connection session in the IMS network during the MT VoNR call, according to an embodiment of the disclosure;

FIG. 7 is a sequence diagram illustrating a method for handling a de-registration procedure in a 5G network, according to an embodiment of the disclosure;

FIG. 8 shows various hardware components of the MME, according to an embodiment of the disclosure;

FIG. 9 shows various hardware components of the PCRF entity, according to an embodiment of the disclosure;

FIG. 10 shows various hardware components of an AMF entity, according to an embodiment of the disclosure;

FIG. 11 shows various hardware components of a PCF entity, according to an embodiment of the disclosure;

FIG. 12 is a flow chart illustrating a method for notifying the UE about the MT VOLTE call by using the MME, according to an embodiment of the disclosure; and

FIG. 13 is a flow chart illustrating a method for notifying a UE about the MT VoNR call by using the AMF entity, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the disclosure described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve a method for handling a data connection session in an IMS network. The method includes configuring a S50 interface between an MME and a PCRF entity in the IMS network. Further, the method includes notifying a UE about a MT VOLTE call by using the MME.

Unlike methods according to the related art, the proposed method may be used to set up an IMS PDU session/PDN connection when required (On-demand IMS PDU session/PDN connection for a VoNR/a VOLTE) and release the PDU session/PDN connection when it is not required. Based on the existing method, when the IMS PDU session/PDN connection is released when there is no data floating on the IMS PDU session/PDN connection for specified amount of time, even a UE IP address of the IMS PDU session/the PDN connection is released including the UE context of the IMS PDU session/PDN connection. Hence, the released IMS UE IP address may be used for other UEs who make IMS PDU session/PDN connection. So that, limited number of IMS UE IP addresses are sufficient to serve a greater number of IMS UEs, as all the UEs may not require IMS PDU session/PDN connection at the same time. Thus, an operator may plan more Internet IP addresses and less IMS IP addresses which may increase number of subscribers supported by a core network.

In other words, the method has the capability to inform the UE about mobile terminated (MT) VOLTE/VONR call even when there is no IMS PDU session/PDN connection established from UE, the 4G/5G core network does not need to keep IMS PDU session/PDN connection when there is no traffic. IMS PDU session/PDN connection may be established when required, and may be released when not required.

The proposed method may be used to increase number of subscribers supported by the core network (e.g., 4G core network, 5G core network) with the same physical resources by having more Internet IP addresses and less IMS IP addresses. The IMS IP addresses are reused across the subscribers (assigned on need basis). Every UE needs Internet PDU session/PDN connection. However, IMS PDU session/PDN connection may be established on the need basis.

In other words, as part of the IP address planning, the operator may manage subscribers with reduced number of ‘IMS’ DNN/APN IP addresses. The operator does not need to reserve 1:1 IMS IP addresses for its subscribers. However, the operator may reserve “Internet” IP addresses 1:1 for the subscribers. The operator may use the remaining IMS IP pool to have more “Internet” PDU sessions/PDN connections. With more “Internet” IP addresses, operator may support more subscribers in 5G/4G core network with the same infrastructure/servers.

The proposed method may be used to define a S50 interface between an MME and a PCRF entity, and Rx messages to notify UE about MT VOLTE/VONR call. The proposed method may be used to configure a SBI interface between an AMF entity and a PCF entity in the IMS network.

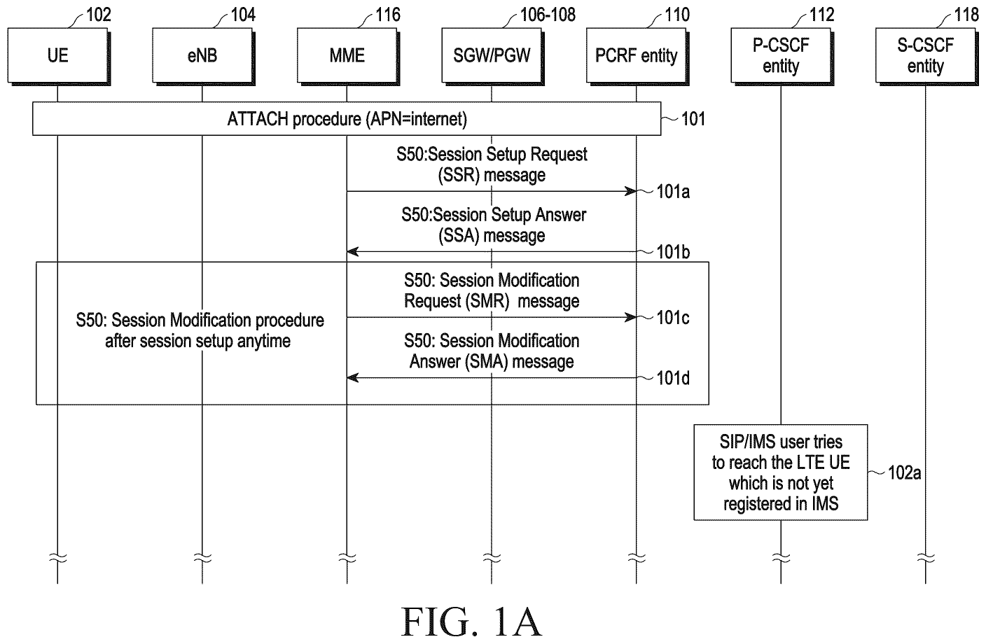

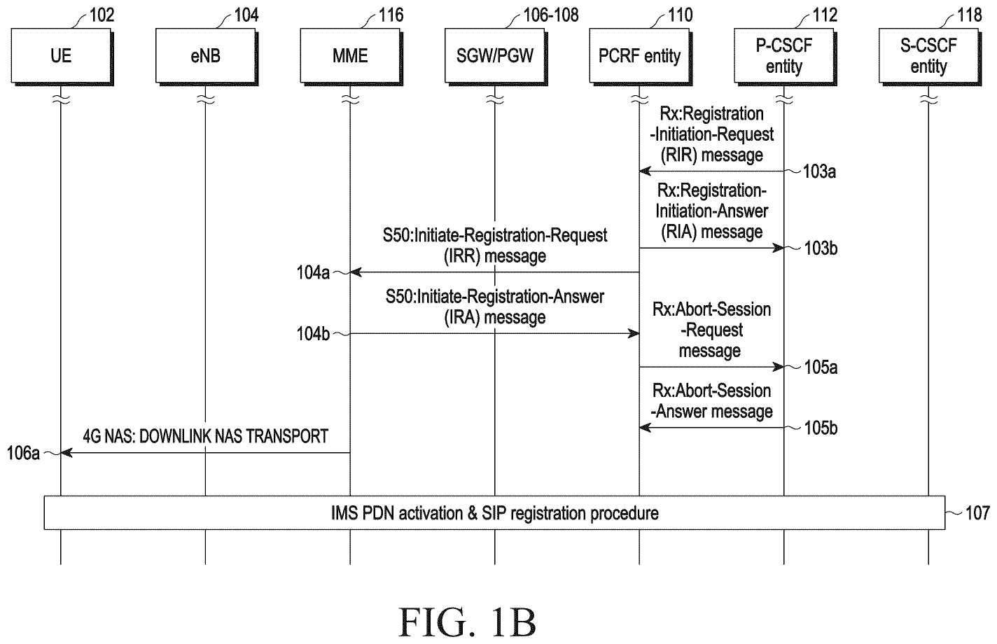

Referring now to the drawings, and more particularly to FIGS. 1A, 1B, 2 to 4, 5A, 5B and 6 through 13, where similar reference characters denote corresponding features consistently throughout the figures, there are shown embodiments.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

FIGS. 1A and 1B are a sequence diagrams illustrating a method for handling a data connection session in an IMS network during a MT VOLTE call, according to various embodiments of the disclosure.

Referring to FIGS. 1A and 1B, the IMS network 100 includes a UE 102, an eNB 104, a SGW 106, a PGW 108, a PCRF entity 110, a P-CSCF entity 112, a S-CSCF entity 118 and an MME 116.

At operation 101, after the UE 102 is attached with an LTE through an access point name (APN) as internet, the MME 116 registers with a PCRF entity 110 over an S50 interface. At operation 101a, the MME 116 sends a S50: session setup request (SSR) message to the PCRF entity 110 to setup a S50 UE session at the PCRF entity 110. The session-setup-request (SSR) message, indicated by a command-code field set to 350 and a ‘R’ bit set in a command flags field, is sent by the MME 116 to the PCRF entity 110 in order to setup the UE association. Below is the message format for the SSR message.

```
<Session-Setup-Request> ::= <Diameter Header: 350, REQ, PXY>
      <Session-Id>
      [DRMP]
      {Auth-Application-Id}
      {Origin-Host}
      {Origin-Realm}
      {Destination-Realm}
      [Destination-Host]
      [Origin-State-Id]
      [OC-Supported-Features]
      [Supported-Features]
    [Subscription-Id]
      [Network-Request-Support]
    [3GPP-RAT-Type]
      [Calling-Party-Address]
  [AN-Trusted]
      [RAT-Type]
      [Proxy-Info]
      [Route-Record]
      [AVP]
```

At operation 101b, after creating the UE context, the PCRF entity 110 sends a S50: session setup answer (SSA) to the MME 116. The session-setup-answer (SSA), indicated by a command-code field set to 350 and a ‘R’ bit cleared in a command flags field, is sent by the PCRF entity 110 to the MME 116 in response to the SSR command. Below is the message format of the SSA.

```
<Session-Setup-Answer> ::= <Diameter Header: 350, PXY>
  <Session-Id>
  [DRMP]
  {Auth-Application-Id}
  {Origin-Host}
  {Origin-Realm}
  [Result-Code]
  [Experimental-Result]
  [OC-Supported-Features]
  [Supported-Features]
  [Origin-State-Id]
  [Redirect-Host]
  [Redirect-Host-Usage]
  [Redirect-Max-Cache-Time]
  [Error-Message]
  [Error-Reporting-Host]
  [Failed-AVP]
  [Proxy-Info]
  [Route-Record]
  [AVP]
```

At operations 101c and 101d, the MME 116 may optionally modify a S50 session any time after session setup by sending a S50: session modification request (SMR) to the PCRF entity 110, and the PCRF entity 110 may send a S50: session modification answer (SMA) to the MME 116. The session-modification-request (SMR), indicated by a command-code field set to 353 and a ‘R’ bit set in the command flags field, is sent by the MME 116 to the PCRF entity 110 in order to modify UE association. Below is the message format of the SMR.

```
  <Session-Modification-Request> ::= <Diameter Header: 353, REQ,
PXY>
      <Session-Id>
      [DRMP]
      {Auth-Application-Id}
      {Origin-Host}
      {Origin-Realm}
      {Destination-Realm}
      [Destination-Host]
      [Origin-State-Id]
      [OC-Supported-Features]
      [Supported-Features]
    [Subscription-Id]
      [Network-Request-Support]
      [3GPP-RAT-Type]
      [Calling-Party-Address]
      [RAT-Type]
      [Proxy-Info]
      [Route-Record]
      [AVP]
```

Further, the session-modification-answer (SMA), indicated by a command-code field set to 353 and the ‘R’ bit cleared in a command flags field, is sent by the PCRF entity 110 to the MME 116 in response to the SMR command. Below is the message format of the SMA.

```
<Session-Modification-Answer> ::= <Diameter Header: 353, PXY>
  <Session-Id>
  [DRMP]
  {Auth-Application-Id}
  {Origin-Host}
  {Origin-Realm}
  [Result-Code]
  [Experimental-Result]
  [OC-Supported-Features]
  [Supported-Features]
  [Origin-State-Id]
  [Redirect-Host]
  [Redirect-Host-Usage]
  [Redirect-Max-Cache-Time]
  [Error-Message]
  [Error-Reporting-Host]
  [Failed-AVP]
  [Proxy-Info]
  [Route-Record]
  [AVP]
```

At operation 102a, if a SIP/IMS user tries to reach the LTE UE 102 which is not yet registered in the IMS 100, the P-CSCF entity 112 decides to notify the PCRF entity 110 over a Rx interface about Mobile-Terminated VOLTE call.

At 103a, the P-CSCF entity 112 sends a Rx: registration-initiation-request (RIR) to the PCRF entity 110 over the Rx interface, as the UE 102 is not yet registered in the IMS network 100. The registration-initiation-request (RIR), indicated by the command-code field set to 354 and the ‘R’ bit set in the command flags field, is sent by the AF (P-CSCF) entity 112 to the PCRF entity 110 indicating about IMS MT VOLTE call. Below is the message format of the RIR.

```
  <Registration-Initiation-Request> ::= <Diameter Header: 354, REQ,
PXY>
        <Session-Id>
        [DRMP]
        {Auth-Application-Id}
        {Origin-Host}
        {Origin-Realm}
        {Destination-Realm}
        [Destination-Host]
        [Auth-Session-State]
        [AF-Application-Identifier]
        [Media-Component-Description]
        [Specific-Action]
        [Subscription-Id]
    [OC-Supported-Features]
        [Supported-Features]
      [Reservation-Priority]
        [Calling-Party-Address]
        [Callee-Information]
        [Origin-State-Id]
        [Proxy-Info]
        [Route-Record]
        [AVP]
```

However, at operation 101d, the UE 102 was already registered at the PCRF entity 110 over the S50 interface. Accordingly, the PCRF entity 110 sends an Rx: registration-initiation-answer (RIA) to the P-CSCF entity 112 in operation 103b. The Rx: RIR and Rx: RIA messages are new messages.

The registration-initiation-answer (RIA), indicated by a command-code field set to 354 and a ‘R’ bit cleared in the command flags field, is sent by the PCRF to the AF (i.e., P-CSCF entity 112) in response to the RIR command. Below is the message format of the RIA.

```
<Registration-Initiation-Answer> ::= <Diameter Header: 354, PXY>
  <Session-Id>
  [DRMP]
  {Auth-Application-Id}
  {Origin-Host}
  {Origin-Realm}
  [Result-Code]
  [Experimental-Result]
  [OC-Supported-Features]
  [Subscription-Id]
  [Error-Message]
  [Error-Reporting-Host]
  [Failed-AVP]
  [Origin-State-Id]
  [Redirect-Host]
  [Redirect-Host-Usage]
  [Redirect-Max-Cache-Time]
  [Proxy-Info]
  [Load]
  [AVP]
```

In the existing implementation, the IMS network 100 drops the SIP call as the LTE UE 102 is not yet registered in the IMS network 100 in this scenario. In case the PCRF entity 110 does not find the UE context over the S50 interface, the PCRF entity 110 sends a failure in Rx: RIA to the P-CSCF entity 112. Experimental-Result-Code shall be set to INVALID_USER.

At operation 104a, the PCRF entity 110 sends a S50: Initiate-Registration-Request (IRR) to the MME 116 over the S50 interface as the UE context is already available with the PCRF entity 110 over the S50 interface which was established during a UE attach procedure. The initiate-registration-request (IRR), indicated by the command-code field set to 352 and the ‘R’ bit set in the command flags field, is sent by the PCRF entity 110 to the MME 116 indicating to send IMS MT VOLTE call notification to UE. Below is the message format of the IRR.

```
  <Initiate-Registration-Request> ::= <Diameter Header: 352, REQ,
PXY>
    <Session-Id>
    [DRMP]
    {Auth-Application-Id}
    {Origin-Host}
    {Origin-Realm}
    {Destination-Realm}
    {Destination-Host}
    [Origin-State-Id]
    [OC-Supported-Features]
    [Event-Trigger]
    [Proxy-Info]
    [Route-Record]
    [AVP]
```

At operation 104b, the MME 116 sends a S50: initiate-registration-answer (IRA) to the PCRF entity 110. The initiate-registration-answer (IRA) command, indicated by the command-code field set to 352 and the ‘R’ bit cleared in the command flags field, is sent by the MME 116 to the PCRF entity 110 in response to the IRR command. Below is the message format of the IRA.

```
<Initiate-Registration-Answer> ::= <Diameter Header: 352, PXY>
  <Session-Id>
  [DRMP]
  {Origin-Host}
  {Origin-Realm}
  [Result-Code]
  [Experimental-Result]
  [Origin-State-Id]
  [OC-Supported-Features]
  [Error-Message]
  [Error-Reporting-Host]
  [Failed-AVP]
  [Proxy-Info]
  [AVP]
```

At operation 105a, after receiving the S50: IRA from the MME 116, the PCRF entity 110 sends a Rx: Abort-Session-Request to the P-CSCF entity 112 with new enum LOCAL_RELEASE for abort-cause AVP to clean up the Rx session context. The abort-session-request (ASR) command, indicated by a command-code field set to 274 and the ‘R’ bit set in the command flags field, is sent by the PCRF entity 110 to inform the AF (i.e., P-CSCF entity 112) that a bearer for the established session is no longer available. A new enum LOCAL_RELEASE (5) is created for abort-cause AVP to clean up the resources locally at the P-CSCF entity 112 only and no action is taken at an I-CSCF entity 114 and the S-CSCF entity 118. Below is the message for the ASR.

```
<AS-Request> ::= <Diameter Header: 274, REQ, PXY>
  <Session-Id>
  [DRMP]
  Origin-Host}
  {Origin-Realm}
  {Destination-Realm}
  {Destination-Host}
  {Auth-Application-Id}
  [OC-Supported-Features]
  {Abort-Cause}
  [Origin-State-Id]
  [Proxy-Info]
  [Route-Record]
  [AVP]
```

At operation 105b, the P-CSCF entity 112 sends an Rx: Abort-Session-Answer to the PCRF entity 110. This performs just the local clean-up at the P-CSCF entity 112. The S50 session context will be retained. At operation 106a, the MME 116 sends the 4G NAS: DOWNLINK NAS TRANSPORT to the UE 102. For NAS message container type “Event notification”, the NAS message container content includes a new event notification indicator (IMS session establishment required). At operation 107, the UE 102 initiates the IMS PDN connection for the VOLTE. The P-CSCF entity 112 forwards a SIP-INVITE to the LTE UE 102 over the IMS PDN connection. The network initiated dedicated bearer will be setup for the LTE UE 102 for the VOLTE call.

According to an embodiment of the disclosure, the MME 116 sends the NAS: DOWNLINK NAS TRANSPORT message to the UE where a new IE ‘NAS message container type’ IE is set to “Event notification” to notify the UE 102 about the mobile terminated VOLTE call. For the NAS message container type “Event notification”, the NAS message container contents include an event notification indicator (IMS session establishment required). The UE 102 initiates IMS PDU session after receiving the NAS message as shown in Table 1.

TABLE 1

| IE/Group Name | Presence | |
|---|---|---|
| Protocol discriminator | Protocol discriminator 9.2 | Mandatory (M) |
| Security header type | Security header type 9.3.1 | M |
| Downlink NAS transport | Message type 9.8 | M |
| message identity | | |
| NAS message container | NAS message container | M |
| | 9.9.3.22 | |
| NAS message container | NAS message container | M |
| type | type 9.9.3.68 | |

Table 2 indicates the NAS message container type information element (IE) (new).

TABLE 2

| | | | | | | | |
|---|---|---|---|---|---|---|---|
| 8 | 7 | 6 | 5 | 4 | 3 | 2 | 1 |

| | | |
|---|---|---|
| NAS message container type | NAS message container | octet 1 |
| IEI | type value | |

TABLE 3
Payload container type value (octet 1)
Bits

| | | | | |
|---|---|---|---|---|
| 4 | 3 | 2 | 1 | |
| 0 | 0 | 0 | 1 | SMS |
| 0 | 0 | 1 | 0 | Event Notification |
| 1 | 1 | 1 | 1 | Multiple payloads |

All other values are reserved.

The 4G NAS: DOWNLINK NAS TRANSPORT has “NAS message container type (new)” and “NAS message container (modified)” IEs.

As shown in Table 4, for the NAS message container type “Event notification”, the NAS message container content includes the event notification indicator (i.e., IMS session establishment required). The NAS message container (modified) information element for NAS message container type “Event Notification”.

TABLE 4
Bits

| 8 | 7 | 6 | 5 | 4 | 3 | 2 | 1 | |
|---|---|---|---|---|---|---|---|---|
| 0 | 0 | 0 | 0 | 0 | 0 | 0 | 0 | SRVCC handover cancelled, IMS |
| | | | | | | | | session re-establishment required” |
| | | | | | | | | indicator |
| 0 | 0 | 0 | 0 | 0 | 0 | 0 | 1 | IMS session establishment |
| | | | | | | | | Required indicator |
| 0 | 0 | 0 | 0 | 0 | 0 | 1 | 0 | |
| To | | | | | | | | Unused, shall be ignored if |
| 1 | 1 | 1 | 1 | 1 | 1 | 1 | 1 | received by the UE |

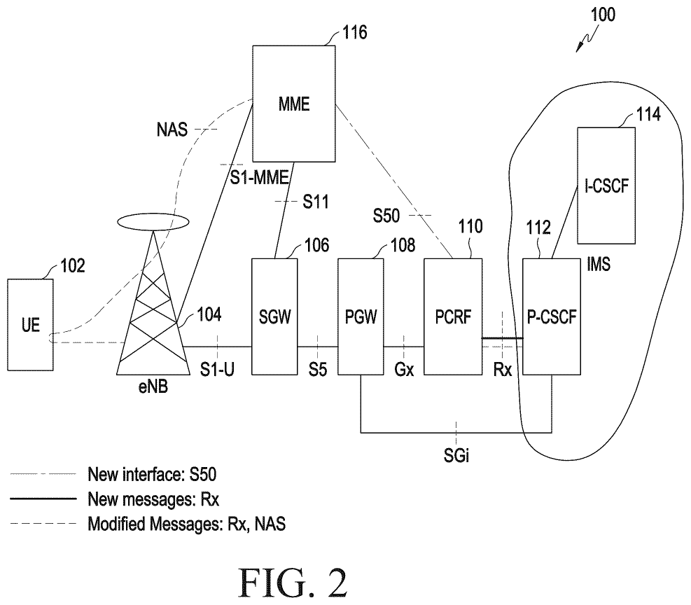

FIG. 2 illustrates a 4G core network architecture in which the 4G core network architecture handles the data connection session in the IMS network during the MT VOLTE call, according to an embodiment of the disclosure.

Referring to FIG. 2, the IMS network 100 includes the UE 102, the eNB 104, the SGW 106, the PGW 108, the PCRF entity 110, the P-CSCF entity 112, the S-CSCF entity 118 and the MME 116. The operations and functions of the UE 102, the eNB 104, the SGW 106, the PGW 108, the PCRF entity 110, the P-CSCF entity 112, the S-CSCF entity 118 and the MME 116 are already explained in the FIGS. 1A and 1B. For the sake of brevity, we are not explaining the same in the patent disclosure.

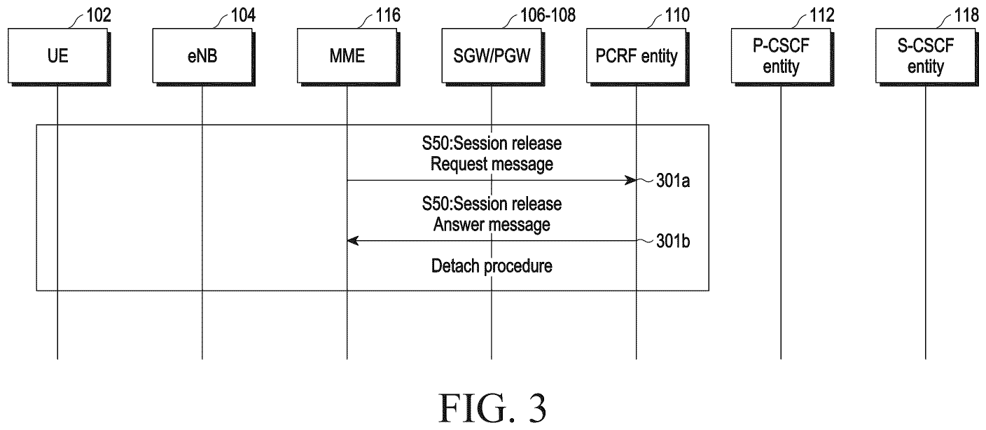

FIG. 3 is a sequence diagram illustrating a method for handling an LTE/4G detach procedure, according to an embodiment of the disclosure.

Referring to FIG. 3, when the PGW 108 notices that there is no voice traffic on the dedicated bearer of the IMS PDN connection for some specified time, the PGW 108 initiates a S5/S8: delete bearer request with LBI. This will initiate the network initiated PDN deactivation procedure. During the IMS PDU connection release procedure, the PGW 108 sends a CC-request-type (TERMINATE_REQUEST) in a Gx: CC-request to the PCRF entity 110. The PCRF entity 110 sends a Rx: abort-session-request (ASR) with abort-cause AVP set to “BEARER RELEASED” to the P-CSCF entity 112. The P-CSCF entity 112 sends a Rx: abort-session-answer (ASA) to the PCRF entity 110. This result in both the local clean-up at the P-CSCF entity 112 and a clean-up at a S-CSCF entity 118 as well. Beyond this point, if an IMS user (caller) sends the SIP: INVITE message to the called-party (i.e., LTE UE), the procedure is same as mentioned in the operations 102a to 107 of FIGS. 1A and 1B.

The deactivation of the IMS PDN (for the VOLTE) will not release the UE S50 Session. The S50 session is maintained as long as at least one PDN connection of UE 102 is maintained. The S50 session is released when the UE 102 is detached. Based on the proposed method, the concept of releasing the IMS PDN connection when there is no traffic for certain amount of time is unique. In the existing deployments, IMS PDN connection is never released to enable the MT VOLTE call.

The MME 116 shall follow all steps of 3GPP LTE UE 102 detach procedure except removing UE context. At operation 301a, the MME 116 shall send a S50: session release request to the PCRF entity 110 to remove the S50 session context. The session release request (SRR) command, indicated by a command-code field set to 351 and the ‘R’ bit set in the command flags field, is sent by the MME 116 to the PCRF entity 110 in order to release UE association. Below is the format of the SRR.

```
<Session-Release-Request> ::= <Diameter Header: 351, REQ, PXY>
  <Session-Id>
  [DRMP]
  {Auth-Application-Id}
  {Origin-Host}
  {Origin-Realm}
  {Destination-Realm}
  [Destination-Host]
  [Origin-State-Id]
  [Subscription-Id]
  [OC-Supported-Features]
  [Proxy-Info]
  [Route-Record]
  [AVP]
```

At operation 301b, after receiving the S50: Session Release Answer from the PCRF entity 110, the MME 116 shall remove the UE context. The Session-Release-Answer (SRA), indicated by a Command-Code field set to 351 and the ‘R’ bit cleared in the sommand flags field, is sent by the PCRF entity 110 to the MME 116 in response to the SRR command. Below is the message format of SRA.

```
<Session-Release-Answer> ::= <Diameter Header: 351, PXY>
  <Session-Id>
  [DRMP]
  {Auth-Application-Id}
  {Origin-Host}
  {Origin-Realm}
  [Result-Code]
  [Experimental-Result]
  [OC-Supported-Features]
  [Origin-State-Id]
  [Redirect-Host]
  [Redirect-Host-Usage]
  [Redirect-Max-Cache-Time]
  [Error-Message]
  [Error-Reporting-Host]
  [Failed-AVP]
  [Proxy-Info]
  [Route-Record]
  [AVP]
```

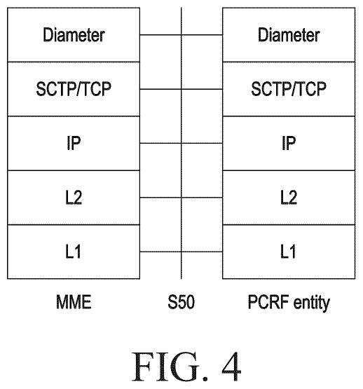

FIG. 4 illustrates a S50 protocol stack proposed between the MME 116 and the PCRF entity 110, according to an embodiment of the disclosure.

Referring to FIG. 4, a new diameter application S50 is introduced between the MME 116 and the PCRF entity 110.

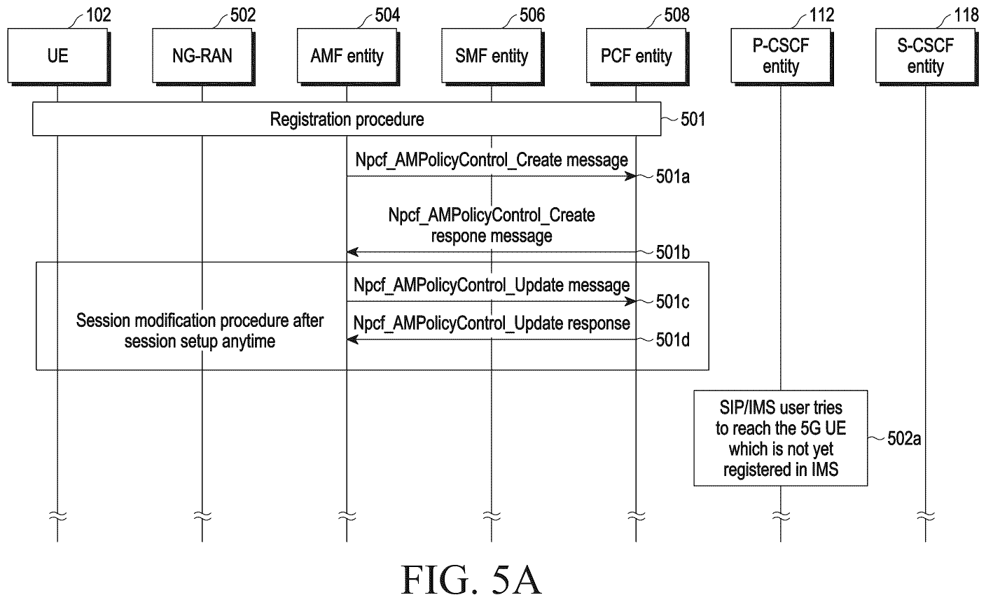

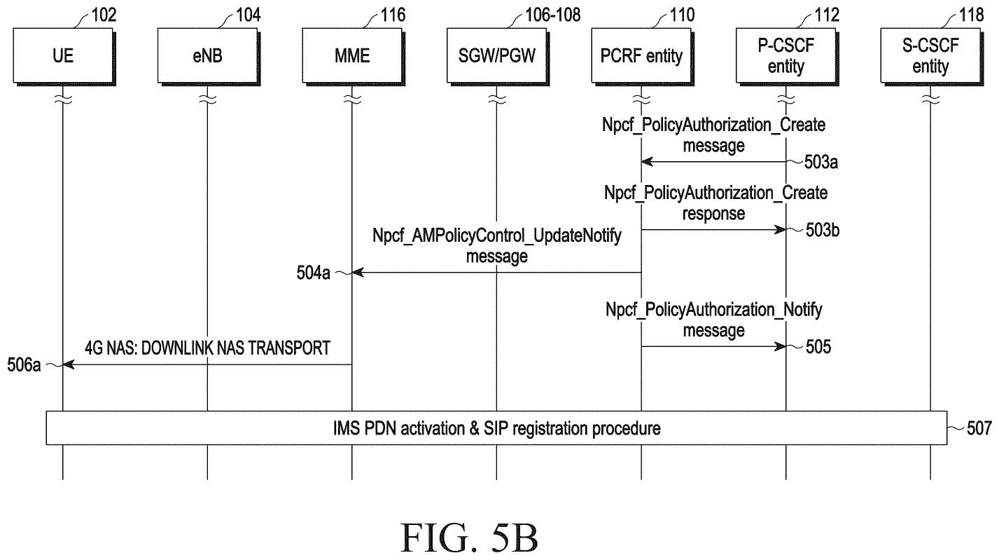

FIGS. 5A and 5B are a sequence diagrams illustrating a method for handling the data connection session in the IMS network 100 during a MT VoNR call, according to various embodiments of the disclosure.

Referring to FIGS. 5A and 5B, the IMS network 100 includes the UE 102, the P-CSCF entity 112, the S-CSCF entity 118, a NG-RAN 502, an AMF entity 504, a SMF entity 506, a PCF entity 508 and a UPF entity 510.

At operation 501, after the UE 102 is registered in the 5G, the AMF entity 504 registers with the PCF entity 508 over a SBI interface. At operation 501a, the AMF entity 504 sends a Npcf_AMPolicyControl_Create message to the PCF entity 508 to setup the UE session at the PCF entity 508. At operation 501b, after creating the UE context, the PCF entity 508 sends a Npcf_AMPolicyControl_Create response to the AMF entity 504. The AMF entity 504 may optionally modify the session any time after session setup by sending Npcf_AMPolicyControl_Update to the PCF entity 508, at operation 501c. At operation 501d, the PCF entity 508 sends a Npcf_AMPolicyControl_Update response to the AMF entity 504.

At operation 502a, if the SIP/IMS user tries to reach the 5G UE 102 which is not yet registered in the IMS network 100, the P-CSCF entity 112 decides to notify the PCF entity 508 over a SBI interface about the MT VONR call.

At operation 503a, the P-CSCF entity 112 sends a Npcf_PolicyAuthorization_Create with “mtVoNRTrigger” to the PCF entity 508 over a SBI interface, as the UE 102 is not yet registered in the IMS network 100. However, the UE 102 is already registered at the PCF entity 508 by the AMF entity 504. Accordingly, at operation 503b, the PCF entity 508 sends a Npcf_PolicyAuthorization_Create response to the P-CSCF entity 112. In the existing implementation, the IMS network 100 drops the SIP call as the 5G UE 102 is not yet registered in the IMS network 100 in this scenario. In case the PCF entity 508 does not find the UE context over the SBI interface (e.g., AMF entity 504 to the PCF entity 508), the PCF entity 508 sends a failure in Npcf_PolicyAuthorization_Create response to the P-CSCF entity 112. The error value shall be set to INVALID_USER.

At operation 504a, the PCF entity 508 sends a Npcf_AMPolicyControl_UpdateNotify with “mtVoNRTrigger” to the AMF entity 504 over the SBI interface as the UE context is already available with the PCF entity 508 over the SBI interface which was established during a UE registration procedure. At operation 505, the PCF entity 508 sends a Npcf_PolicyAuthorization_Notify to the P-CSCF entity 112 with “localRelease” EventNotification to perform ‘Notification about application session context termination’ procedure at the P-CSCF entity 112. This performs just the local clean-up at the P-CSCF entity 112. The PCF entity 508 shall retain the UE session context towards the AMF entity 504.

At operation 506a, the AMF entity 504 sends a 5G NAS: DL NAS TRANSPORT to the UE 102. For payload container type “Event notification”, the payload container contents include a new event notification indicator (IMS session establishment required).

At operation 507, the UE 102 initiates the IMS PDU session for the VONR. The P-CSCF entity 112 forwards the SIP-INVITE to the 5G UE 102 over the IMS PDU session. A network initiated PDU session modification takes place for the 5G UE 102 for the VoNR call.

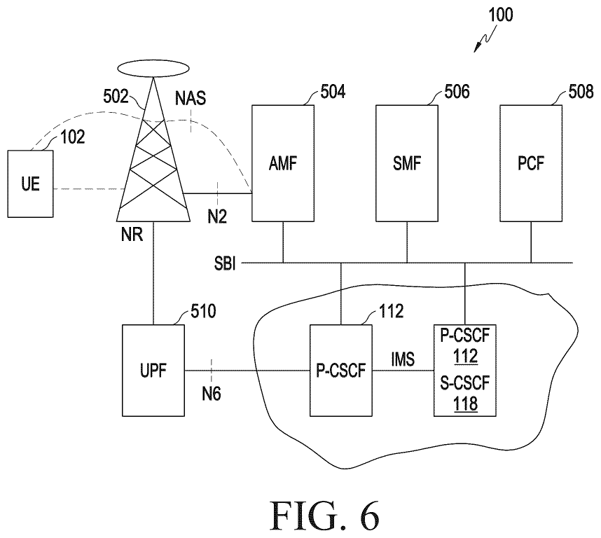

FIG. 6 illustrates a 5G core network architecture in which the 5G core network architecture handles the data connection session in the IMS network during the MT VoNR call, according to an embodiment of the disclosure.

Referring to FIG. 6, the IMS network 100 includes the UE 102, the P-CSCF entity 112, the S-CSCF entity 118, the NG-RAN 502, the AMF entity 504, the SMF entity 506, the PCF entity 508 and the UPF entity 510. The operations and functions of the UE 102, the P-CSCF entity 112, the S-CSCF entity 118, the NG-RAN 502, the AMF entity 504, the SMF entity 506, the PCF entity 508 and the UPF entity 510 are explained in the FIGS. 5A and 5B. For the sake of brevity, those elements that have been discussed above will not be discussed again.

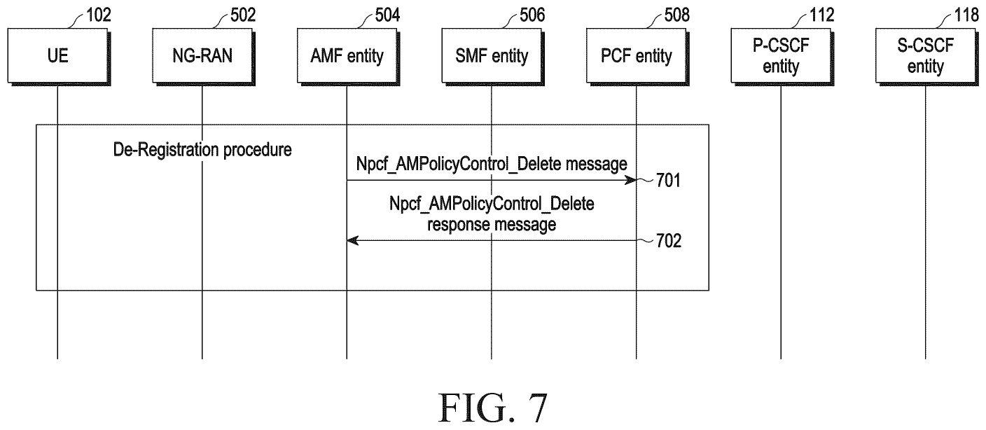

FIG. 7 is a sequence diagram illustrating a method for handling a de-registration procedure in a 5G network, according to an embodiment of the disclosure.

Referring to FIG. 7, when the UPF entity 510 notices that there is no voice traffic on the IMS PDU session for some specified time, the UFP entity 510 initiates deactivation of the IMS PDU session by sending a PFCP session report request. After receiving the report, a session management function (SMF) entity 506 initiates the IMS PDU deactivation procedure. During IMS PDU connection release procedure, the SMF entity 506 invokes a Npcf_SMPolicyControl_Delete service operation to request the deletion of the SM Policy Association with the PCF entity 508.

The PCF entity 508 sends a Npcf_PolicyAuthorization_Notify to the P-CSCF entity 112 to perform ‘Notification about application session context termination’ procedure. This performs both the local clean-up at the P-CSCF entity 112 and a clean-up at the S-CSCF entity 118 as well.

Beyond this point, if an IMS user sends the invite message to the called-party (i.e., 5G UE), the procedure is same as mentioned operations 502a to 507 of FIGS. 5A and 5B.

The deactivation of the IMS PDU (for the VoNR call) does not release the UE session between the AMF entity 504 and the PCF entity 508, as the session is not associated with any PDU session. The session is created during 5G REGISTRATION procedure.

The AMF entity 504 shall follow all steps of 3GPP 5G UE De-Registration procedure except removing UE context. At operation 701, the AMF entity 504 sends a Npcf_AMPolicyControl_Delete to the PCF entity 508 to remove the UE session context (i.e., AMF entity 504 to the PCF entity 508). At operation 702, after receiving Npcf_AMPolicyControl_Delete response from the PCF entity 508, the AMF entity 504 shall remove the UE context.

Npcf_AMPolicyControl_UpdateNotify Service Operation: The PCF entity 508 may decide to update policies or to request the termination of the policy association and shall use an Npcf_AMPolicyControl_UpdateNotify service operation. The PCF entity 508 shall provide an attribute (mtVoNRTrigger) in “PolicyUpdate” data structure as request body. Table 5 indicates the definition of type PolicyUpdate.

TABLE 5

| | | | | | |
|---|---|---|---|---|---|
| Attribute | Data | | | | |
| name | type | P | Cardinality | Description | Applicability |

| | | | | |
|---|---|---|---|---|
| . . . | | | | |
| mtVoNRTrigger | boolean | O | 0 . . . 1 | When this attribute is |
| | | | | included and set to |
| | | | | true, it indicates |
| | | | | that the MT (Mobile |
| | | | | Terminated) VoNR |
| | | | | call is triggered. |
| | | | | When present it shall |
| | | | | be set as follows: |
| | | | | true: MT VoNR |
| | | | | triggered. |
| | | | | false (default): MT |
| | | | | VoNR not triggered. |

Npcf_PolicyAuthorization_Create Service Operation: The Npcf_PolicyAuthorization_Create service operation authorizes the request from the AF (e.g., P-CSCF entity 112) and optionally communicates with Npcf_SMPolicyControl service to determine and install the policy according to the information provided by the P-CSCF entity 112. The P-CSCF entity 112 provides an attribute (mtVoNRTrigger) in “AppSessionContextReqData” data structure as request body.

TABLE 6

| | | | | | |
|---|---|---|---|---|---|
| Attribute | Data | | | | |
| name | type | P | Cardinality | Description | Applicability |

| | | | | |
|---|---|---|---|---|
| . . . | | | | |
| mtVoNRTrigger | boolean | O | 0 . . . 1 | When this |
| | | | | attribute is |
| | | | | included and set |
| | | | | to true, it |
| | | | | indicates that |
| | | | | the MT (Mobile |
| | | | | Terminated) VoNR |
| | | | | call is triggered. |
| | | | | When present it |
| | | | | shall be set as |
| | | | | follows: |
| | | | | true: MT VoNR |
| | | | | triggered. |
| | | | | false (default): |
| | | | | MT VoNR not |
| | | | | triggered. |

Npcf_PolicyAuthorization_Notify Service Operation: The Npcf_PolicyAuthorization_Notify service operation enables notification to the P-CSCF entity 112 that the previously subscribed event for the existing application session context occurred or that the application session context is no longer valid. The PCF entity 508 shall provide an attribute (localRelease) in “EventsNotification” data structure as request body as shown in Table 7.

TABLE 7

| | | | | | |
|---|---|---|---|---|---|
| Attribute | Data | | | | |
| name | type | P | Cardinality | Description | Applicability |

| | | | | |
|---|---|---|---|---|
| . . . | | | | |
| localRelease | Boolean | O | 0 . . . 1 | When this attribute is |
| | | | | included and set to true, |
| | | | | it indicates that the |
| | | | | session needs to be |
| | | | | released at P-CSCF only. |
| | | | | When present it shall |
| | | | | be set as follows: |
| | | | | true: Session release |
| | | | | at P-CSCF only. |
| | | | | false (default): |
| | | | | Session release at |
| | | | | P-CSCF/I-CSCF an S-CSCF. |

The AMF entity 504 sends a NAS: DL NAS TRANSPORT message to the UE 102, where ‘Payload container type’ IE is set to “Event notification” to notify UE 102 about the Mobile Terminated VoNR call. For payload container type “Event notification”, the payload container contents include an event notification indicator (IMS session establishment required) (as shown in Table 8). The UE 102 initiates IMS PDU session after receiving the NAS message.

TABLE 8
Bits

| 8 | 7 | 6 | 5 | 4 | 3 | 2 | 1 | |
|---|---|---|---|---|---|---|---|---|
| 0 | 0 | 0 | 0 | 0 | 0 | 0 | 0 | SRVCC handover cancelled, |
| | | | | | | | | IMS session re-establishment |
| | | | | | | | | required” indicator |
| 0 | 0 | 0 | 0 | 0 | 0 | 0 | 1 | IMS session establishment |
| | | | | | | | | Required indicator |
| 0 | 0 | 0 | 0 | 0 | 0 | 1 | 0 | |
| To | | | | | | | | Unused, shall be ignored if |
| 1 | 1 | 1 | 1 | 1 | 1 | 1 | 1 | received by the UE |

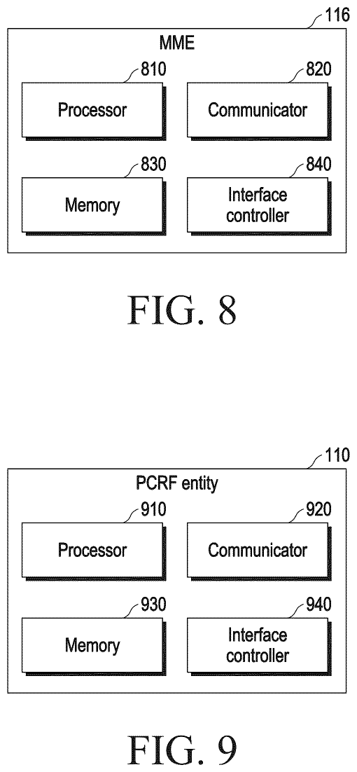

FIG. 8 shows various hardware components of the MME 116, according to an embodiment of the disclosure.

Referring to FIG. 8, the MME 116 includes a processor 810, a communicator 820, memory 830 and an interface controller 840. The processor 810 is coupled with the communicator 820, the memory 830, and the interface controller 840.

The interface controller 840 registers with the PCRF entity 110 over the S50 interface, after the UE 102 is attached in the IMS network 100. Upon registering, the interface controller 840 sends a S50: SSR to the PCRF entity 110 to setup a S50 UE session at the PCRF entity 110. Based on the S50: SSR, the interface controller 840 receives a S50: SSA from the PCRF entity 110, after the PCRF entity 110 creates the UE context.

The interface controller 840 may be implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 810 may include one or more processors. The one or more processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 810 may include multiple cores and is configured to execute the instructions stored in the memory 830.

The processor 810 is configured to execute instructions stored in the memory 830 and to perform various processes. The communicator 820 is configured for communicating internally between internal hardware components and with external devices via one or more networks. The memory 830 also stores instructions to be executed by the processor 810. The memory 830 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 830 may, in some examples, be considered a non-transitory storage medium. The term “non-transitory” may indicate that the storage medium is not embodied in a carrier wave or a propagated signal. However, the term “non-transitory” should not be interpreted that the memory 830 is non-movable. In certain examples, a non-transitory storage medium may store data that may, over time, change (e.g., in random access memory (RAM) or cache).

Although FIG. 8 shows various hardware components of the MME 116 but it is to be understood that other embodiments are not limited thereto. In other embodiments, the MME 116 may include a different number of components. Further, the labels or names of the components are used for illustrative purpose and does not limit the scope of the disclosure. One or more components may be combined together to perform same or substantially similar function in the MME 116.

FIG. 9 shows various hardware components of the PCRF entity 110, according to an embodiment of the disclosure.

Referring to FIG. 9, the PCRF entity 110 includes a processor 910, a communicator 920, memory 930 and an interface controller 940. The processor 910 is coupled with the communicator 920, the memory 930 and the interface controller 940.

The interface controller 940 receives the RIR from the P-CSCF entity 112 over the Rx interface, upon determining the UE 102 is not yet registered in the IMS network 100 by the P-CSCF entity 112. Based on the RIR, the interface controller 940 sends the Rx: registration-initiation-answer (RIA) to the P-CSCF entity 112. Further, the interface controller 940 sends the S50: initiate-registration-request (IRR) to the MME 116 over the S50 interface upon determining the UE context is already available with the PCRF entity 110 over the S50 interface. The MME 116 sends the S50: initiate-registration-answer (IRA) to the PCRF entity 110. Further, the interface controller 940 sends a Rx: abort-session-request to the P-CSCF entity 112 with the local_release for an abort-cause AVP to clean up the Rx session context after receiving the S50: IRA from the MME 116. Based on the Rx: abort-session-request, the interface controller 940 receives the Rx: abort-session-answer from the P-CSCF entity 112.

The interface controller 940 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 910 may include one or more processors. The one or more processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 910 may include multiple cores and is configured to execute the instructions stored in the memory 930.

The processor 910 is configured to execute instructions stored in the memory 930 and to perform various processes. The communicator 920 is configured for communicating internally between internal hardware components and with external devices via one or more networks. The memory 930 also stores instructions to be executed by the processor 910. The memory 930 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 930 may, in some examples, be considered a non-transitory storage medium. The term “non-transitory” may indicate that the storage medium is not embodied in a carrier wave or a propagated signal. However, the term “non-transitory” should not be interpreted that the memory 930 is non-movable. In certain examples, a non-transitory storage medium may store data that may, over time, change (e.g., in random access memory (RAM) or cache).

Although FIG. 9 shows various hardware components of the PCRF entity 110 but it is to be understood that other embodiments are not limited thereon. In other embodiments, the PCRF entity 110 may include a different number of components. Further, the labels or names of the components are used for illustrative purpose and does not limit the scope of the disclosure. One or more components may be combined together to perform same or substantially similar function in the PCRF entity 110.

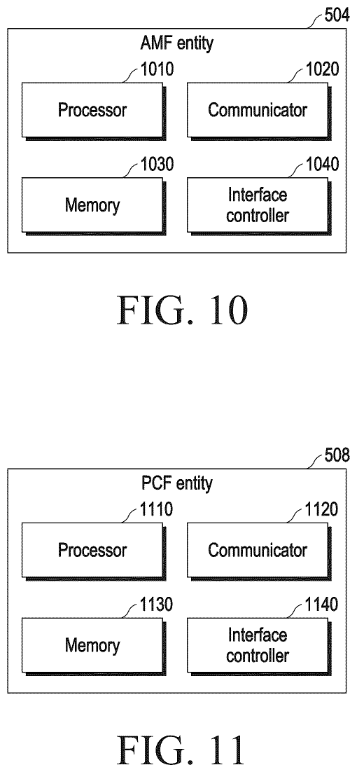

FIG. 10 shows various hardware components of the AMF entity 504, according to an embodiment of the disclosure.

Referring to FIG. 10, the AMF entity 504 includes a processor 1010, a communicator 1020, memory 1030 and an interface controller 1040. The processor 1010 is coupled with the communicator 1020, the memory 1030 and the interface controller 1040.

The interface controller 1040 registers with the PCF entity 508 over the SBI interface, after the UE 102 is registered in the 5G network. Upon registration, the interface controller 1040 sends the Npcf_AMPolicyControl_Create message to the PCF entity 508 to setup the UE session at the PCF entity 508. Further, the interface controller 1040 receives a Npcf_AMPolicyControl_Create response from the PCF entity 508, after creating a UE context.

The interface controller 1040 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 1010 may include one or more processors. The one or more processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 1010 may include multiple cores and is configured to execute the instructions stored in the memory 1030.

The processor 1010 is configured to execute instructions stored in the memory 1030 and to perform various processes. The communicator 1020 is configured for communicating internally between internal hardware components and with external devices via one or more networks. The memory 1030 also stores instructions to be executed by the processor 1010. The memory 1030 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 1030 may, in some examples, be considered a non-transitory storage medium. The term “non-transitory” may indicate that the storage medium is not embodied in a carrier wave or a propagated signal. However, the term “non-transitory” should not be interpreted that the memory 1030 is non-movable. In certain examples, a non-transitory storage medium may store data that may, over time, change (e.g., in random access memory (RAM) or cache).

Although FIG. 10 shows various hardware components of the AMF entity 504 but it is to be understood that other embodiments are not limited thereon. In other embodiments, the AMF entity 504 may include a different number of components. Further, the labels or names of the components are used for illustrative purpose and does not limit the scope of the disclosure. One or more components may be combined together to perform same or substantially similar function in the AMF entity 504.

FIG. 11 shows various hardware components of the PCF entity 508, according to an embodiment of the disclosure.

Referring to FIG. 11, the PCF entity 508 includes a processor 1110, a communicator 1120, memory 1130 and an interface controller 1140. The processor 1110 is coupled with the communicator 1120, the memory 1130 and the interface controller 1140.

The interface controller 1140 the receives Npcf_PolicyAuthorization_Create with “mtVoNRTrigger” from the P-CSCF entity 112 over the SBI interface upon determining the UE 102 is not yet registered in the IMS network 100 by the P-CSCF entity 112. Further, the interface controller 1140 sends the Npcf_PolicyAuthorization_Create response to the P-CSCF entity 112. Further, the interface controller 1140 sends a Npcf_AMPolicyControl_UpdateNotify with “mtVoNRTrigger” to the AMF entity 504 over the SBI interface upon determining that the UE context is already available with the PCF entity 508 over the SBI interface. The UE context is provided during a UE registration procedure. Further, the interface controller 1140 sends a Npcf_PolicyAuthorization_Notify to the P-CSCF entity 112 with a local Release EventNotification to perform a notification about an application session context termination' procedure at the P-CSCF entity 112.

The interface controller 1140 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 1110 may include one or more processors. The one or more processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 1110 may include multiple cores and is configured to execute the instructions stored in the memory 1130.

The processor 1110 is configured to execute instructions stored in the memory 1130 and to perform various processes. The communicator 1120 is configured for communicating internally between internal hardware components and with external devices via one or more networks. The memory 1130 also stores instructions to be executed by the processor 1110. The memory 1130 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 1130 may, in some examples, be considered a non-transitory storage medium. The term “non-transitory” may indicate that the storage medium is not embodied in a carrier wave or a propagated signal. However, the term “non-transitory” should not be interpreted that the memory 1130 is non-movable. In certain examples, a non-transitory storage medium may store data that may, over time, change (e.g., in random access memory (RAM) or cache).

Although FIG. 11 shows various hardware components of the PCF entity 508 but it is to be understood that other embodiments are not limited thereon. In other embodiments, the PCF entity 50) may include a different number of components. Further, the labels or names of the components are used for illustrative purpose and does not limit the scope of the disclosure. One or more components may be combined together to perform same or substantially similar function in the PCF entity 508.

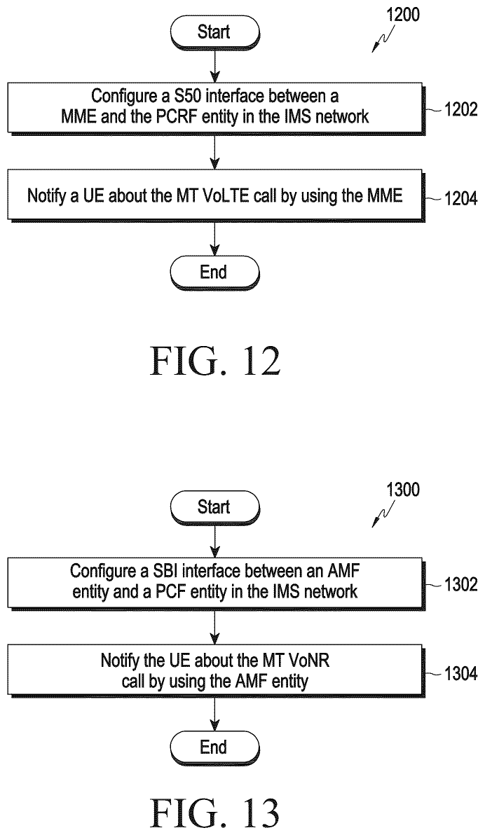

FIG. 12 is a flow chart 1200 illustrating a method for notifying the UE about the MT VOLTE call by using the MME, according to an embodiment of the disclosure.

Referring to FIG. 12, at 1202, the an S50 interface is configured between the MME 116 and the PCRF entity 110 in the IMS network 100. At operation 1204, the UE 102 is notified about the MT VOLTE call by using the MME 116.

FIG. 13 is a flow chart 1300 illustrating a method for notifying a UE about the MT VoNR call by using the AMF entity 504, according to an embodiment of the disclosure.

Referring to FIG. 13, at operation 1302, a SBI interface is configured between the AMF entity 504 and the PCF entity 508 in the IMS network 100. At operation 1304, the UE 102 is notified about the MT VoNR call by using the AMF entity 504.

The method has the capability to inform the UE 102 about the Mobile Terminated VOLTE/VONR call even when there is no IMS PDU session/PDN connection established from the UE 102, the 4G/5G core network does not need to keep IMS PDU session/PDN connection when there is no traffic. IMS PDU session/PDN connection may be established when required, and may be released when not required.

Based on the proposed method, the operator may increase number of subscribers supported by the core network (e.g., 4G core network, 5G core network) with the same physical resources by having more “Internet” DNN/APN IP addresses and less “IMS” DNN/APN IP addresses.

As part of the IP address planning, the operator may manage subscribers with reduced number of ‘IMS’ DNN/APN IP addresses. The operator does not need to reserve 1:1 IMS IP addresses for its subscribers. However, operator may reserve “Internet” IP addresses 1:1 for the subscribers. Operator may use the remaining IMS IP pool to have more “Internet” PDU sessions/PDN connections. With more “Internet” IP addresses, operator may support more subscribers in 5G/4G core network with the same infrastructure/servers.

The various actions, acts, blocks, steps, or the like in the flow charts 1200 and 1300 may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein may be implemented through at least one software program running on at least one hardware device and performing network management functions to control the network elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

The foregoing description of the various embodiments will so fully reveal the general nature of the embodiments herein that others can, by applying current knowledge, readily modify and/or adapt for various applications such various embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for handling a data connection session in an internet protocol (IP) multimedia subsystem (IMS) network, the method comprising:
registering, by a first entity, with a second entity over an interface between the first network entity and the second network entity;
establishing, by the first entity, a user equipment (UE) session with the second entity;
receiving, by the first entity from the second entity over the interface, a first message indicating to transmit a call notification to the UE in case that there is an attempt to connect to the UE that is not registered to the IMS network; and
notifying, by the first entity, the UE about a mobile terminated (MT) voice over long term evolution (VOLTE) call or a mobile terminated (MT) voice over new radio (VoNR) call.

2. The method as claimed in claim 1, wherein the establishing the UE session with the second entity comprising:
sending, by the first entity, a Npcf_AMPolicyControl_Create message to the second entity to setup the UE session at the second entity; and
receiving, by the first entity, a Npcf_AMPolicyControl_Create response from the second entity, after creating a UE context.

3. The method as claimed in claim 2,
wherein the first message is a Npcf_AMPolicyControl_UpdateNotify with “mtVoNRTrigger” and the UE context is available with the second entity over the interface, and
wherein the UE context is provided during the registration procedure.

4. The method as claimed in claim 3,
wherein the notifying the UE about the MT VoNR call comprising:
sending, by the first entity, a second message to the UE, wherein the UE initiates a IMS protocol data unit (PDU) session for the MT VoNR call, and wherein a SIP-INVITE is forwarded to the UE over the IMS PDU session.

5. The method as claimed in claim 1,
wherein the first entity is an access and mobility management function (AMF) entity and the second entity is a policy control function (PCF) entity, and
wherein the interface is a service based interface (SBI).

6. The method as claimed in claim 1,
wherein the interface handles at least one of:
a session setup request (SSR) signaling message,
a session setup answer (SSA) signaling message,
a session modification request (SMR) signaling message,
a session modification answer (SMA) signaling message,
a session release request (SRR) signaling message,
a session release answer (SRA) signaling message,
an initiate-registration-request (IRR) signaling message, and
an initiate-registration-answer (IRA) signaling message, and
wherein the interface comprises a S50 interface.

7. The method as claimed in claim 1, wherein the establishing the UE session with the second entity comprising:
sending, by the first entity, a session setup request (SSR) to the second entity to setup the UE session at the second entity; and
receiving, by the first entity, a session setup answer (SSA) from the second entity, after the second entity creates a UE context, based on the SSR.

8. The method as claimed in claim 7,
wherein the first message is an initiate-registration-request (IRR) and the UE context is available with the second entity over the interface, and
wherein the first entity sends an initiate-registration-answer (IRA) to the second entity.

9. The method as claimed in claim 8,
wherein the notifying the UE about the MT VOLTE call comprising:
sending, by the first entity, a second message to the UE, wherein the UE initiates a data connection session for the MT VOLTE call, and
wherein a SIP-INVITE is forwarded to the UE over the data connection session.

10. The method as claimed in claim 9, wherein the data connection session is one of an IMS protocol data unit (IMS PDU) session and a packet data network (PDN) connection session, wherein the first entity notifies the UE about the MT VOLTE call using a downlink NAS transport when the UE is not registered in the IMS network.

11. The method as claimed in claim 1,
wherein the first entity is a mobility management entity (MME) and the second entity is a policy and charging rules function (PCRF) entity, and
wherein the interface is an S50 interface.

12. A first entity for handling a data connection session in an internet protocol (IP) multimedia subsystem (IMS) network, comprising:
memory storing instructions; and
at least one processor communicatively coupled to the memory, wherein the at least one processor is configured to execute the instructions to:
register with a second entity over an interface between the first network entity and the second network entity,
establish a user equipment (UE) session with the second entity,
receive, from the second entity over the interface, a first message indicating to transmit a call notification to the UE in case that there is an attempt to connect to the UE that is not registered to the IMS network, and
notify the UE about a mobile terminated (MT) voice over long term evolution (VOLTE) call or a mobile terminated (MT) voice over new radio (VoNR) call.

13. The first entity as claimed in claim 12, wherein to establish the UE session with the second entity, the at least one processor is further configured to execute the instructions to:
send a Npcf_AMPolicyControl_Create message to the second entity to setup the UE session at the second entity, and
receive a Npcf_AMPolicyControl_Create response from the second entity, after creating a UE context.

14. The first entity as claimed in claim 12, wherein the first message is a Npcf_AMPolicyControl_UpdateNotify with “mtVoNRTrigger” and the UE context is available with the second entity over the interface, wherein the UE context is provided during the registration procedure.

15. The first entity as claimed in claim 12,
wherein the first entity is an access and mobility management function (AMF) entity and the second entity is a policy control function (PCF) entity, and
wherein the interface is a service based interface (SBI).

16. The first entity as claimed in claim 12, wherein to establish the UE session with the second entity, the at least one processor is further configured to execute the instructions to:
send a session setup request (SSR) to the second entity to setup the UE session at the second entity, and
receive a session setup answer (SSA) from the second entity, after the second entity creates a UE context, based on the SSR.

17. The first entity as claimed in claim 16,
wherein the first message is an initiate-registration-request (IRR) and the UE context is available with the second entity over the interface, and
wherein the first entity, an initiate-registration-answer (IRA) to the second entity.

18. The first entity as claimed in claim 17,
wherein to notify the UE about the MT VOLTE call, the at least one processor is further configured to execute the instructions to:
send a second message to the UE, wherein the UE initiates a data connection session for the MT VOLTE call, and
wherein a SIP-INVITE is forwarded to the UE over the data connection session.

19. The first entity as claimed in claim 17,
wherein the first entity is a mobility management entity (MME) and the second entity is a policy and charging rules function (PCRF) entity, and
wherein the interface is an S50 interface.

20. One or more non-transitory computer-readable storage media storing one or more computer programs including computer-executable instructions that, when executed by one or more processors, cause a first entity to perform operations, the operations comprising:
registering with a second entity over an interface between the first network entity and the second network entity;
establishing a user equipment (UE) session with the second entity;
receiving, from the second entity over the interface, a first message indicating to transmit a call notification to the UE in case that there is an attempt to connect to the UE that is not registered to the IMS network; and
notifying the UE about a mobile terminated (MT) voice over long term evolution (VOLTE) call or a mobile terminated (MT) voice over new radio (VONR) call.
